(19) United States
(12) Patent Application Publication
(10) Pub. No.: US 2001/0020542 A1
(43) Pub. Date: Sep. 13, 2001

(54) Motor cable with ferromagnetic sheathing

(75) Inventor: Volker Schuren, Marktheidenfeld (DE)

Correspondence Address: Thomas C. Pontani, Esq., Cohen, Pontani, Lieberman & Pavane, Suite 1210, 551 Fifth Avenue, New York, NY, 10176, US

(73) Assignee: Atecs Mannesmann AG

(21) Appl. No.: 09/738,569

(22) Filed: Dec. 15, 2000

(30) Foreign Application Priority Data
Dec. 16, 1999 (DE) 199 63 301.0

(51) Int. Cl. H01B 5/14

(52) U.S. Cl. 174/126.4

(57) ABSTRACT

A motor cable for supplying power to a motor from an Insulated-Gate Bipolar Transistor (IGBT) converter with high switching speeds has reduced leakage current in the motor cable and in the motor by including a sheath comprising a ferromagnetic material for enclosing the electrically conducting leads of the cable.

### BACKGROUND OF THE INVENTION

1. Field of the Invention

The present invention is directed to a motor cable for the connection of a converter-operated motor to a power supply.

2. Description of the Related Art

The switching speed of Insulated-Gate Bipolar Transistor (IGBT) converters has increased due to technological advances such that shields are now required in motor cable for converter-operated motors to limit interference radiation. However, the use of the shield produces high leakage currents in the cables which are harmful for the converter. Moreover, leakage currents also flow from the motor winding to the motor housing, inducing bearing currents which damage the bearings. To reduce leakage currents, the voltage gradient du/dt may be reduced at the converter output with chokes or filters. However, because of the required matching to cable length, standardization is very difficult to realize and the filters have a large space requirement. Further, insulated bearings with ceramic balls or insulated oxide films on the outer ring are known to the person skilled in the art for solving the problems, but are very expensive. Motor cables with a particularly low characteristic impedance are recommended for reducing interference emission. However, they result in higher bearing currents.

### SUMMARY OF THE INVENTION

It is the object of the invention to reduce leakage currents in a motor power cable in the most economical and efficient manner possible.

The object is met by a motor power cable in which the conductors, i.e., leads, are enclosed by a ferromagnetic sheathing comprising a ferromagnetic material.

The asymmetric line inductance and accordingly the characteristic impedance of the motor cable is increased by the ferromagnetic sheathing (e.g., ferrite polymer) in the form of an intermediate layer arranged between the conductors and the outer jacket or shield of the motor cable. The increased asymmetric impedance reduces leakage current in the cable and, consequently, in the motor, while the useful current is not affected in principle.

The ferromagnetic intermediate layer may be arranged so that it directly surrounds the individual conductors or leads (power cable) of the motor cable. If the individual conductors have a conductor insulation then the ferromagnetic intermediate layer surrounds the conductor insulation. Alternatively, the ferromagnetic intermediate layer may be arranged to surround a filler material which directly encloses the leads.

The ferromagnetic intermediate layer is preferably formed so as to be flexible and may be made of flexible ferrite.

Since a PE conductor (protective ground) may not be arranged inside the ferrite sheathing to achieve the desired aim, the outer shield may also be used as a PE connection.

The various features of novelty which characterize the invention are pointed out with particularity in the claims annexed to and forming a part of the disclosure. For a better understanding of the invention, its operating advantages, and specific objects attained by its use, reference should be had to the drawing and descriptive matter in which there are illustrated and described preferred embodiments of the invention.

### BRIEF DESCRIPTION OF THE DRAWINGS

Further features and advantages of the invention are indicated in the following description of an embodiment example with reference to the drawing, wherein:

FIG. 1 is a sectional view of a three-conductor motor cable according to an embodiment of the present invention; and

FIG. 2 is a sectional view of another embodiment of a three-conductor motor cable according to the present invention with filler material surrounding its conductors.

### DETAILED DESCRIPTION OF THE PRESENTLY PREFERRED EMBODIMENTS

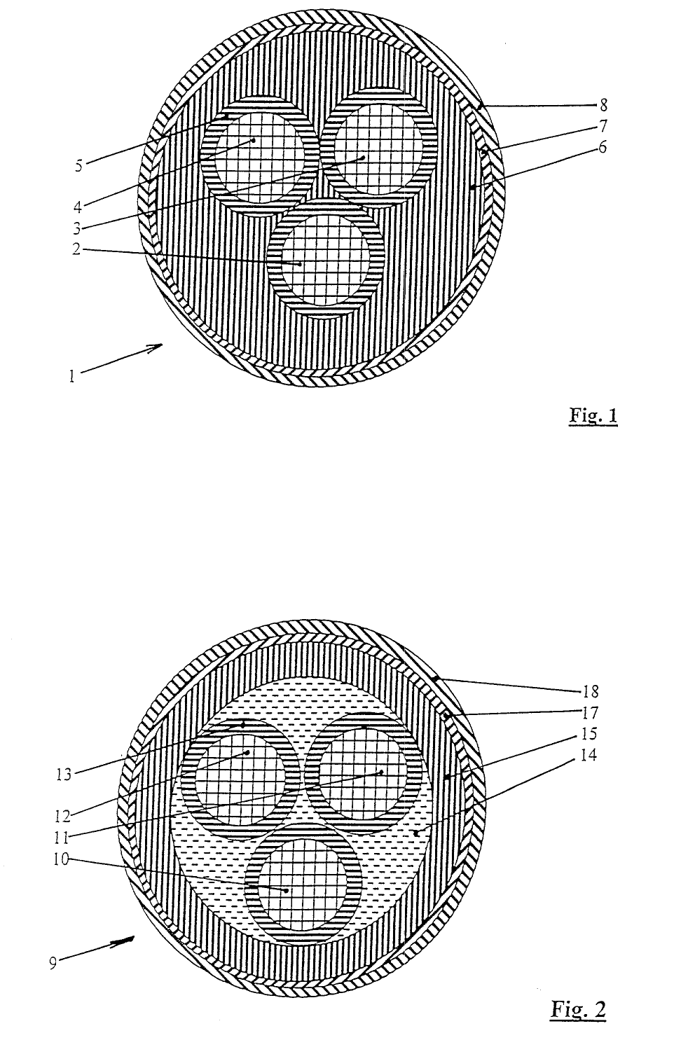

FIG. 1 shows a motor cable 1 according to the present invention with three conductors, i.e., electrically conducting leads 2, 3, 4. A conductor insulation 5 surrounds each of the electrically conducting leads 2, 3, 4. The conductor insulations 5 of the three electrically conducting leads 2, 3, 4 are enclosed by a ferromagnetic intermediate layer 6 of ferromagnetic material such as, for example, a ferrite polymer or a flexible ferrite. The ferromagnetic intermediate layer 6 is enclosed by an electrically conducting shield 7. The shield 7 is enclosed by an electrically insulating outer jacket 8. The shield 7 may be omitted such that the intermediate layer 6 which encloses the leads 2, 3, 4 or a filler material surrounding the latter, is surrounded directly by the outer jacket 8.

Another embodiment of a motor cable 9 according to the present invention is shown in FIG. 2. The motor cable 9 also includes three electrically conducting leads 10, 11, 12, each of which is surrounded by a conductor insulation 13. However, to economize on ferromagnetic material, a filler material 14 —which is not made of ferromagnetic material but, rather, comprises a conventional cable filler material —is arranged so that the filler material 14 encloses the entire strand formed by the three electrically conducting leads 10, 11, 12. The filler material 14 is enclosed by a ferromagnetic intermediate layer 15 which is surrounded by a shield 17. The shield 17 is enclosed by an insulating outer jacket 18. As in the previous embodiment, the shield 17 may be omitted so that the ferromagnetic intermediate layer 15 is enclosed directly by the insulating outer jacket 18.

The ferromagnetic intermediate layers 6 and 15 in respective FIGS. 1 and 2 increase the asymmetric line inductance and accordingly the characteristic impedance of the respective motor cables 1 and 9. The leakage current in the cables 1 and 9 as well as in the motor to which the cables are connected is reduced by the higher asymmetric inductance.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements which perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

I claim:

1. A motor cable for the connection of a converter-operated motor or other consumer, comprising:
at least one electrically conducting lead and a ferromagnetic material enclosing said at least one electrically conducting lead.

2. The motor cable of claim 1, wherein said at least one electrically conducting lead comprises a plurality of leads.

3. The motor cable of claim 1, further comprising a conductor insulation, wherein said ferromagnetic material comprises a ferromagnetic intermediate layer directly enclosing said at least one electrically conducting lead and said conductor insulation encloses said ferromagnetic intermediate layer.

4. The motor cable of claim 1, further comprising a non-ferromagnetic filler layer enclosing said at least one electrically conducting lead, wherein said ferromagnetic material comprises a ferromagnetic intermediate layer surrounding said non-ferromagnetic filler layer.

5. The motor cable of claim 1, wherein said ferromagnetic material is flexible.

6. The motor cable of claim 1, wherein said ferromagnetic material contains ferrite.

7. The motor cable of claim 1, wherein said motor cable is arranged for connecting a motor to a converter.
